(19) United States
(12) Patent Application Publication
(10) Pub. No.: US 2009/0071395 A1
(43) Pub. Date: Mar. 19, 2009

(54) DISPENSING MACHINE TO ENHANCE THE VISUAL APPEAL OF PREPARED FOODS

(76) Inventor: Charley M. Parks, Austin, TX (US)

Correspondence Address: CHARLEY MICHAEL PARKS, 4105 OAK CREEK DRIVE, AUSTIN, TX, 78727, US

(21) Appl. No.: 12/297,673

(22) PCT Filed: May 2, 2007
(86) PCT No.: PCT/US2007/067980

§ 371 Date: Oct. 20, 2008

Related U.S. Application Data
(60) Provisional application No. 60/796,628, filed on May 2, 2006.

(51) Int. Cl. A21C 9/04; A23G 3/22

(52) U.S. Cl. 118/13; 118/24; 426/304

(57) ABSTRACT

The present invention is a dispensing machine (10) to enhance the visual appeal of prepared foods. The dispensing machine includes one or more temperature controlled storage containers (36) that stores sauces, syrups, or other flowable foods and includes one or more dispensing nozzles (44) for dispensing the same. The dispensing nozzles (44) couple to a movable nozzle assembly (202). Additionally included is a controller (100) that controls the temperature and dispensing of the sauces, syrups, and other flowable foods. The dispensing machine further includes a temperature selection panel (18), a flow rate selection panel (14), and a pattern selection panel (16). Additionally included is a spinning assembly (206) that spins the food serving piece (22). Further included is a centering assembly (204) that centers the food piece (22). And further included is a data port (102) that allows additional access to the controller (100) and the stored patterns (106).

### TECHNICAL FIELD

The present invention generally relates to the field of dispensing liquid or flowable food items. More specifically, the present invention relates to dispensing such items in programmed patterns to form designs on a serving dish and/or food item to enhance its aesthetic appeal.

### BACKGROUND ART

Restaurants typically wish to enhance the visual appeal of the dishes they serve to their patrons. The claim is often made that one eats first with the eyes, then with the nose, and finally, with the mouth. As a result, many chefs will apply sauces or syrups to the plate in an artistic pattern, either before or after placing the main food item on it.

The aesthetic appeal of such an application of syrup or sauce will depend in large part upon the artistic ability of the individual chef and upon the pace of work in the kitchen at a given time. On the other hand, the automation of these plating techniques could enhance the reputation of an individual restaurant by facilitating the use of more detailed and intricate patterns. Additionally, a restaurant chain could create “signature dishes” that have the same visual characterization throughout the organization's individual locations.

The present invention solves the above problems and is a dispensing machine that is capable of applying patterns consisting of one or more sauces and syrups to a serving dish and/or to a food item. The basic patterns are built into the machine. Optionally, additional patterns can be designed on a separate machine, typically a personal computer, and can be uploaded to the dispensing machine. The machine may include temperature control capability to maintain individual syrups and sauces at temperatures required for food safety (hot and/or cold). The machine may include the capability to adjust the flow rate of each sauce to accommodate a range of viscosities. If desired, the machine can automatically center the item to be patterned under the dispensing nozzles. Optionally, the machine can include a spinning assembly to spin the item to be patterned in the horizontal plane under the nozzles to facilitate the creation of some patterns.

This application claims the benefits of the earlier filed U.S. Provisional Application Ser. No. 60/796,628, filed 2 May 2006, which is incorporated by reference for all purposes into this specification.

### BEST MODE FOR CARRYING OUT THE INVENTION

The present invention is a dispensing machine to enhance the visual appeal of prepared foods. The dispensing machine comprises one or more storage containers that store sauces, syrups, or other flowable foods. In addition, the dispense machine includes one or more dispensing nozzles that couple to a corresponding storage container where the dispensing nozzles dispense the sauces, syrups or other flowable foods. The dispensing nozzles couple to a movable nozzle assembly. The dispensing machine further comprises a controller that controls the dispensing of the sauces, syrups, and other flowable foods. The controller couples to the dispensing nozzles and the storage containers. And further included is a pattern selection panel to select a pattern to dispense from one or more stored patterns, where the pattern selection panel couples to the controller. The present invention may include a temperature selection panel coupled to the controller. Also, the present invention may include a flow rate selection panel to select the flow rate of the sauces, syrups, or other flowable foods being dispensed through the dispensing nozzles, where the flow rate selection panel couples to the controller. The present invention may include a spinning assembly that spins the food serving piece. Additionally, the dispensing machine may include a centering assembly that centers the food serving piece. And, the dispensing machine may include a data port that allows additional access to the controller and the stored patterns.

### BRIEF DESCRIPTION OF DRAWINGS

To further aid in understanding the invention, the attached drawings help illustrate specific features of the invention and the following is a brief description of the attached drawings:

FIG. 1 is a perspective view of the present invention.

FIG. 2 is a close up, perspective view of the various control panels of the present invention.

FIG. 3 illustrates a storage container assembly that contains one or more storage containers that store sauces, syrups, and other flowable foods that are dispensed by the present invention.

FIG. 4 is a perspective view of FIG. 3.

FIG. 5 illustrates the movable nozzle assembly that includes one or more dispensing nozzles that dispenses sauces, syrups, and other flowable foods.

FIGS. 6A and 6B illustrate a centering assembly to center the serving dish under the dispensing nozzles to ensure proper alignment of the pattern on the dish.

FIG. 7 illustrates a spinning assembly that spins the item to be patterned in a horizontal plane to facilitate the creation of certain design patterns.

FIG. 8 is a system block diagram of the present invention.

### DISCLOSURE OF INVENTION

The present invention is a method and apparatus for a dispensing machine that uses syrups, sauces, or other flowable foods to create a pattern on a serving dish such as a plate or a bowl, on a food item such as a cake, or upon a food item and the serving dish on which it is placed. This disclosure describes numerous specific details. One skilled in the art will appreciate that one may practice this invention without these specific details. Additionally, this disclosure does not describe some well known items in detail in order not to obscure the present invention.

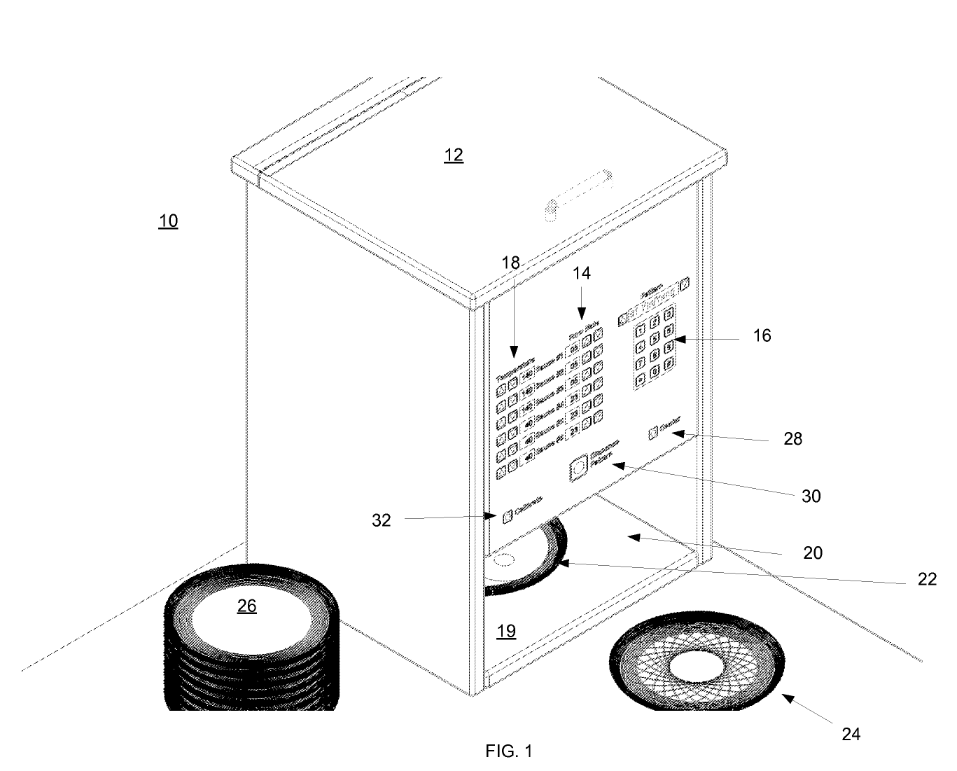

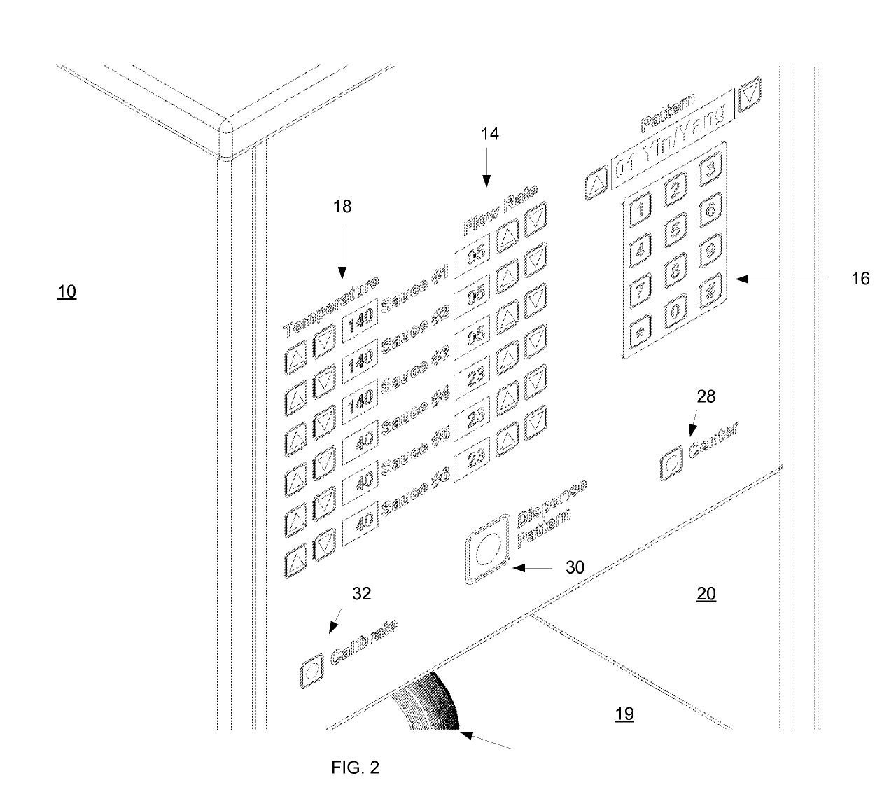

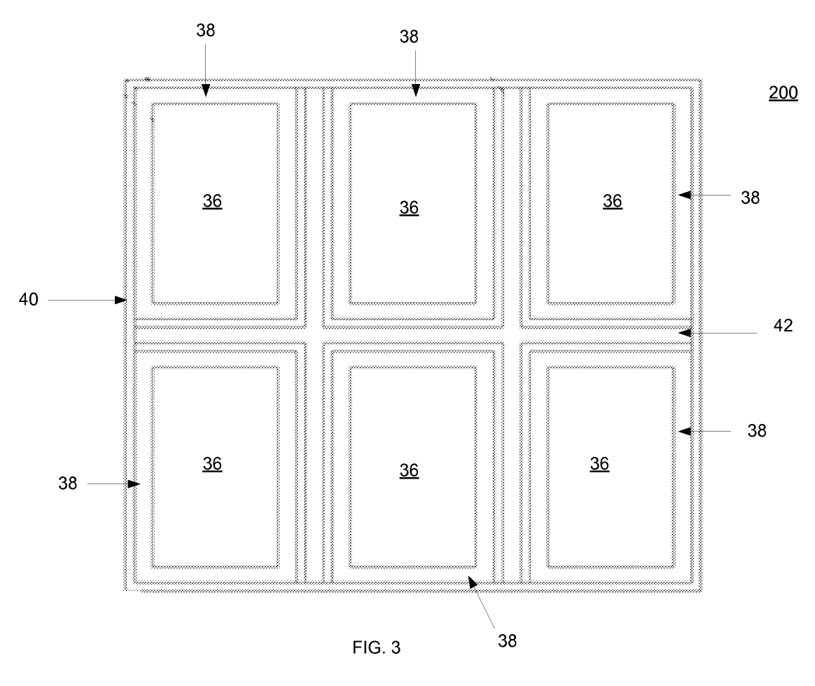

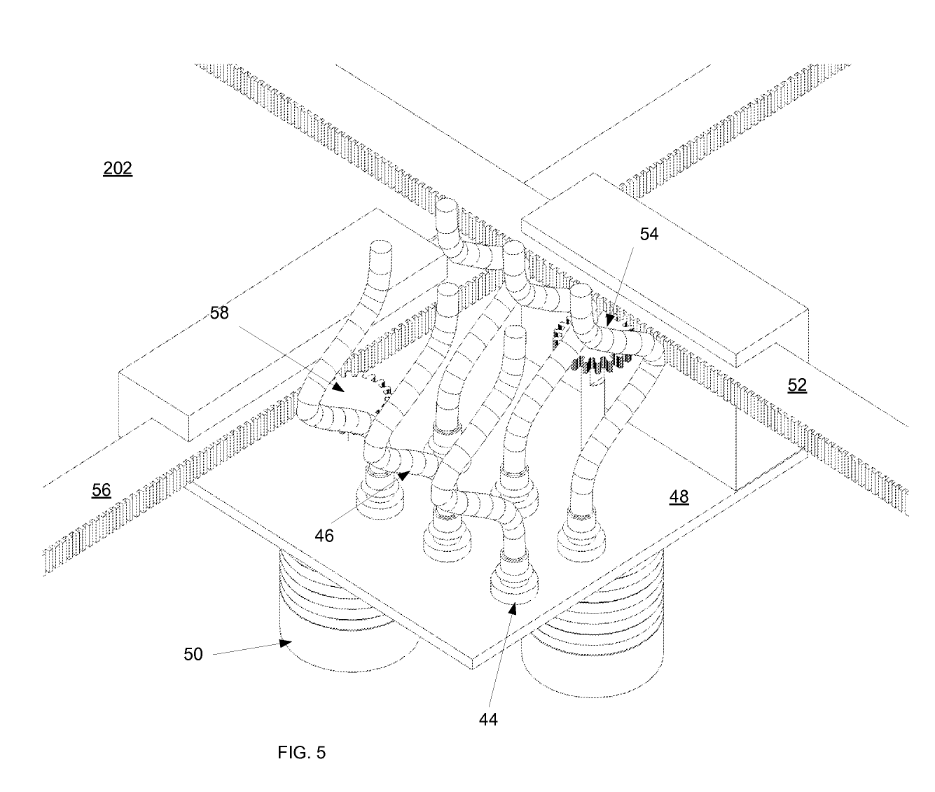

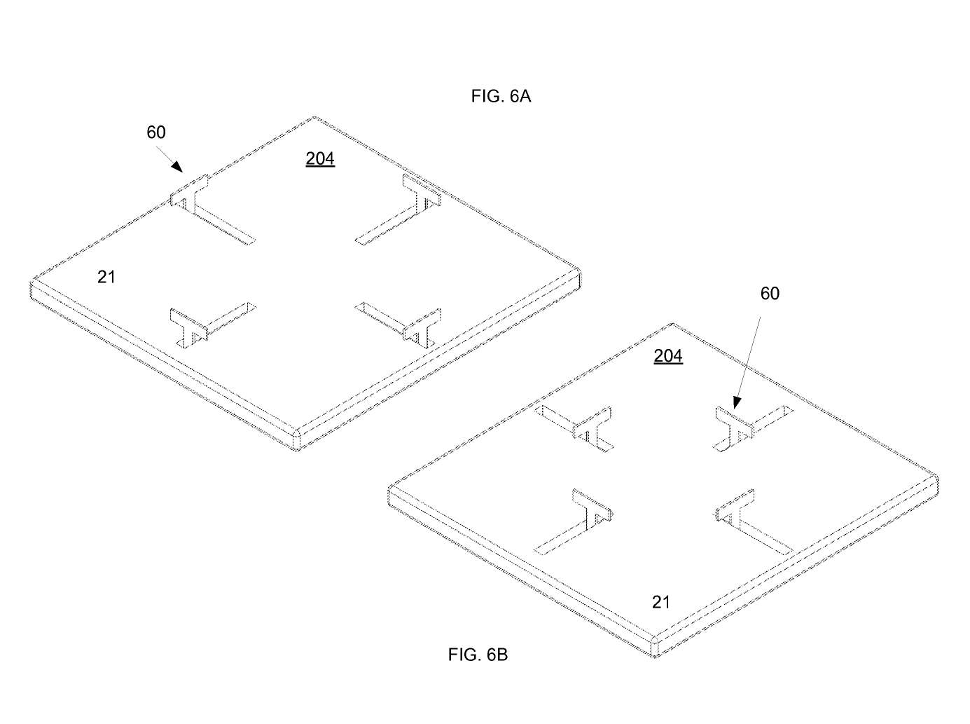

FIGS. 1 and 2 illustrate the present invention that is a dispensing machine 10 to enhance the visual appeal of prepared foods. The dispensing machine features a lid 12 that allows easy access to the storage container assembly 200 as shown in FIG. 3. The dispensing machine 10 also includes a number of selection panels that provide user access to all of the functionality of the machine 10. The selection panels include the following: flow rate selection panel 14, pattern selection panel 16, temperature selection panel 18, center selection 28, dispense pattern start button 30, and calibrate start button 32. The temperature selection panel 18 allows the user of the machine 10 to select the temperature of the temperature controlled storage containers 36 (on FIG. 3). The flow rate selection panel 14 allows the user to select the flow rate of the items being dispensed through dispensing nozzles 44 (on FIG. 5). And, the pattern selection panel 16 allows the user to select a pattern to dispense from one or more stored patterns 106. The center selection 28 allows the user to center a food serving piece 22 such as a plate or other food container on a centering assembly 204 (on FIGS. 6A and 6B). The dispense pattern start button 30 starts the dispensing machine 10 in dispensing the stored syrups, sauces, or other flowable foods. And finally, the calibrate start button 32 allows the user to calibrate various processes in the present invention 10.

The dispensing machine 10 also includes a dispensing area 20 that allows the user of the invention to place a food serving piece 22 into the dispensing machine 10 for processing. The food serving piece 22 rests on the bottom side 19 of the dispensing area 20. The dispensing machine 10 may include the capability to detect the absence of a serving dish or food item and to prevent the dispensing of the flowable food in that situation. After processing, the finished pattern is dispensed on food serving piece 24. The present invention allows a user to quickly, and perfectly process a number of food serving pieces 26 much faster than previously done by hand.

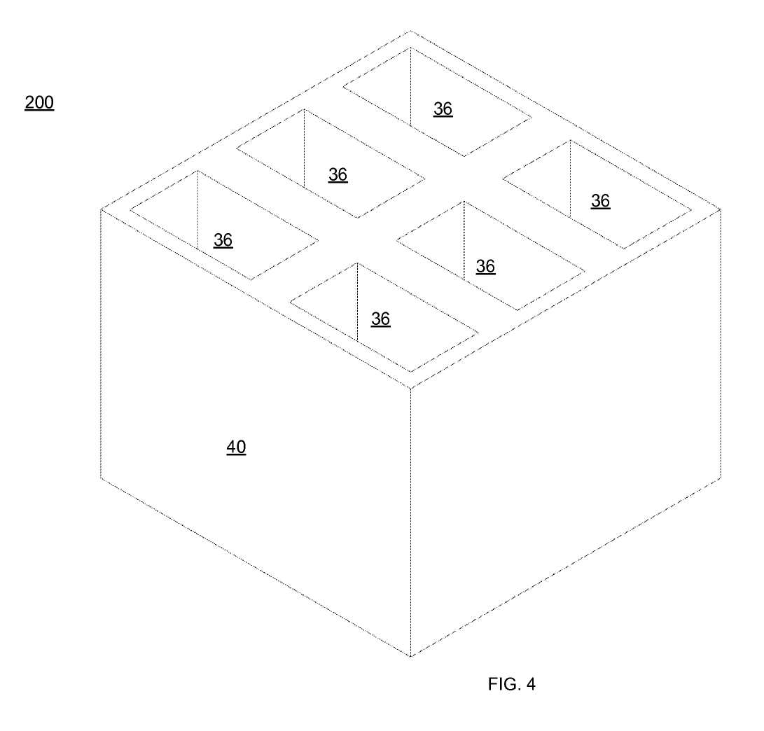

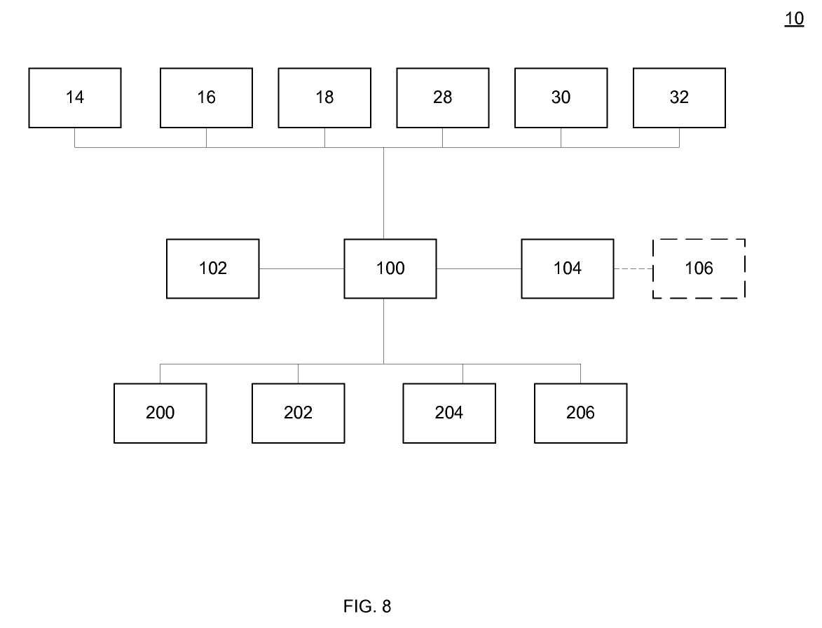

To use the dispensing machine 10, the user first fills one or more temperature controlled storage containers 36 (on FIGS. 3 and 4) with the desired syrup, sauce, or other flowable food. The user then selects the desired holding temperature for each one of the food items using the temperature selection panel 18. In preparation for dispensing, the user adjusts the flow rate of the syrup, sauce, or other flowable food with the flow rate selection panel 14 to ensure that the patterns created by the machine 10 will have the desired appearance. The user then selects the desired pattern using the pattern selection panel 16 from one or more stored patterns 106 (of FIG. 8).

The dispensing machine 10 allows the user to adjust and calibrate the pre-stored patterns 106. This adjustment is accomplished by placing a plate 22 or other dish in the enclosed dispensing area 20 and depressing the calibrate start button 32. The dispensing machine 10 will then apply a short linear portion of each flowable food item to the food serving piece 22. After inspecting the resulting pattern 24 on the food serving piece, the user can increase or decrease the flow rate of each flowable food item independently using the flow rate selection panel 14. The flow rate selection panel 14 also allows the user to individually calibrate the flow rate of each flowable food.

The pattern selection panel 16 allows the user to selects the desired pattern from one or more stored patterns 106. The user can move back and forth through the list of available patterns, or the user can enter the number of the desired pattern on the included keypad. The pattern selection panel 16 includes some type of display such as a liquid crystal display (LCD) that lists the currently selected pattern number and its descriptive name. If the user does not desire to utilize one of the stored patterns 106, then they may transfer a pattern created on a personal computer (not shown) to the dispensing machine 10. This is accomplished by connecting the computer to the dispensing machine 10 through its data port 102. The data port allows the user to access the stored patterns for modification. They user may also add new patterns or even delete currently stored patterns.

After the initial setup is complete, the user places a serving dish 22 into the dispensing area 20. If desired, the user can operate the center selection 28 that automatically centers the dish under the nozzles with the centering assembly 204. The user then presses the dispense pattern start button 30. At this point, the dispensing machine 10 moves the movable nozzle assembly 202 (on FIG. 5) through the desired sequence of motions in a horizontal plane above the food serving piece 22, while controlling the flow of flowable foods through each dispensing nozzle 44 in a timed fashion to create the programmed pattern on the dish and/or food item. The user can then remove the food serving piece 22. If desired, the pattern can be replicated on multiple food serving piece 26. Alternately, a different pattern can be selected before placing the next food serving piece in the dispensing area.

FIGS. 3 and 4 illustrate a storage container assembly 200 that contains one or more temperature controlled storage containers 36 that store sauces, syrups, and other flowable foods that are dispensed by the present invention 10. As illustrated, the temperature controlled storage containers 36 are thermally isolated from each other by a layer of thermal insulation 42. The individual thermal isolation of the storage containers 36 allows the dispensing machine 10 to maintain each storage container 36 at the same or even different hot or a cold temperatures. The temperature control mechanism 38 that surrounds each individual storage container 36 may comprise circulating a heated or cooled fluid through tubing embedded in the interior face of the insulation. Alternatively, the temperature control mechanism may comprise a more direct mechanism such as resistive heating or the use of a Peltier thermoelectric device for heating or cooling. Finally, the outer storage container assembly 40 of the storage container assembly 200 may be made of an appropriate material for the food processing industry such as stainless steel.

FIG. 5 illustrates the movable nozzle assembly 202 that includes one or more dispensing nozzles 44 that dispenses sauces, syrups, and other flowable foods. The dispensing nozzles 44 are mounted on nozzle faceplate 48. As illustrated, the dispensing nozzles 44 are arranged in the nozzle faceplate 48 such that the nozzles point down toward the dispensing area. Each dispensing nozzle 44 is connected by a flexible hose 46 to a small pump (not shown). Each of the pumps is supplied by one of the storage containers 36. The flow rate for each pump is adjustable through operation of the flow rate selection panel 14.

The dispensing nozzles 44 and the face plate 48 are mounted on a carriage and gear arrangement that can be moved both left and right (carriage 52 and gear 54) and from front to back (carriage 56 and gear 58). Stepper motors 50 are used to move the nozzle assembly 202 in the dispensing area so as to help create the desired pattern on the food serving piece 22.

FIGS. 6A and 6B illustrate a centering assembly 204 to center the food serving piece 22 under the dispensing nozzles 44 to ensure proper alignment of the pattern on the food serving piece 22. The centering assembly 204 may sit on top of the bottom side 19 of the dispensing area 20 or it may replace the platter 17 of the spinning assembly 206. The user places the food serving piece 22 into the dispensing area such that it is within the region bounded by the four centering guides 60. FIG. 6A illustrates the guides 60 in the open position on guide mount 21. When the user pushes the center selection 28 on the front panel, a motor (not shown) moves the four guides 60 toward the center of the guide mount 21 as illustrated in FIG. 6B with the guides 60 in the closed position. When all four guides 60 are in contact with the dish, it has been centered under the dispensing nozzles 44. One skilled in the art will appreciate that some type of feedback circuit can indicate to the dispensing machine 10 that the centering guides 60 can be moved back to their standby positions at the outer edge of the guide mount 21.

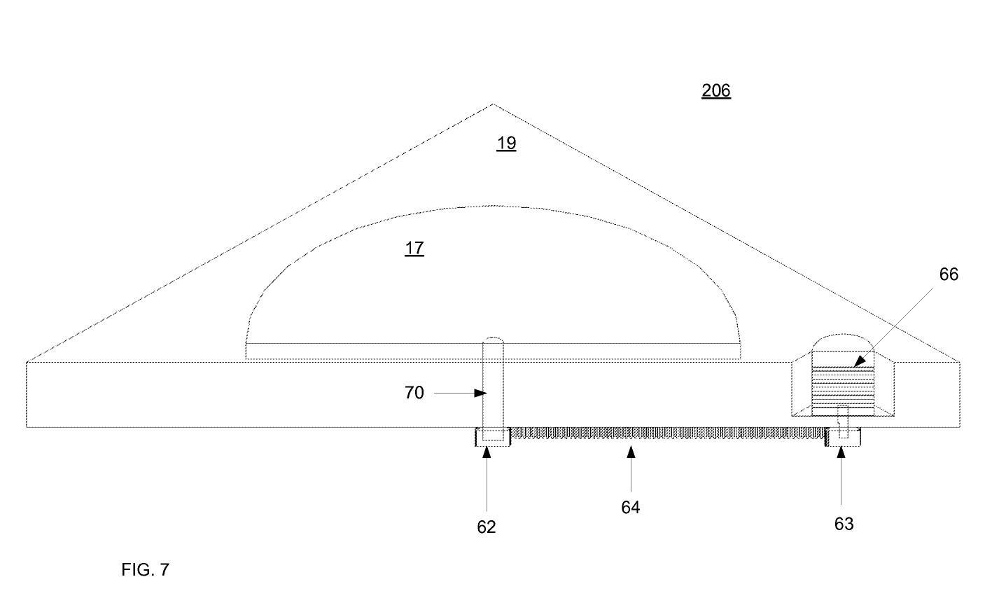

FIG. 7 illustrates a spinning assembly 206 that spins the item to be patterned in a horizontal plane to facilitate the creation of certain design patterns. The food serving piece 22 is placed on a platter 17 that rests on the bottom side 19 of the dispensing area 20 of the invention 10. A shaft 70 is secured to the platter 17, and extends through a hole in the bottom side 19 and has a pulley 62 on its lower end. The pulley 62 is engaged by a drive belt 64. A motor 66, also equipped with a pulley 63 on the end of the motor's 66 drive shaft, engages the other end of the drive belt 64. When the motor 66 is driven, it causes the platter 17 to spin. The spinning motion facilitates the application of certain patterns, such as a spiral. In this case, the platter 17 and the movable nozzle assembly 202 are each driven at a constant speed, resulting in the application of a uniform spiral to the food serving piece 22.

FIG. 8 is a system block diagram of the dispensing machine 10. At the heart of the dispensing machine is the controller 100. The controller 100 controls the temperature and dispensing of the sauces, syrups, and other flowable foods and all other aspects of the dispensing machine 10. One skilled in the art will appreciate that the controller 100 can comprise a computing device such as an embedded computer or it can comprise some type of embedded processor such as a microprocessor, microcontroller, or some type of system on a chip solution. Coupled to the controller 100 is the data port 102. One skilled in the art will appreciate that the data port 102 could comprise a wired or wireless Ethernet port, a USB port, an infra port, a blue-tooth port, or other similar type of data communications. Also coupled to the controller 100 is a storage device 104 that stores the system program for the controller 100 and the stored patterns 106. One skilled in the art will appreciate that the storage device could comprise a hard disk, a flash drive or flash memory, or some other type of non-volatile memory device.

The controller 100 couples to the storage container assembly 200, the movable nozzle assembly 202, the centering assembly 204, and the spinning assembly 206. The controller 100 controls the temperature of the sauces, syrups, and other flowable foods in the storage container assembly 200 that comprises one or more temperature controlled storage containers 36. In addition, the controller 100 controls the movement of the movable nozzle assembly 202 that comprises one or more dispensing nozzles 44. The controller 100 additionally controls the flow rate of the sauces, syrups, and other flowable foods from the storage containers 36 through the dispensing nozzles 44. Further, the controller 100 controls the centering assembly 204 for centering food serving pieces under the dispensing nozzles 44. And, the controller 100 controls the spinning assembly 206 that spins the item to be patterned in a horizontal plane to facilitate the creation of certain design patterns. In addition, the controller 100 takes user input from the flow rate selection panel 14, the pattern selection panel 16, the temperature selection panel 18, center selection 28, the dispense pattern start button 30, and the calibrate start button 32 and initiates and controls the appropriate response in the dispensing machine 10.

To summarize, the present invention is a dispensing machine to enhance the visual appeal of prepared foods. The dispensing machine comprises one or more storage containers that store sauces, syrups, or other flowable foods. In addition, the dispense machine includes one or more dispensing nozzles that couple to a corresponding storage container where the dispensing nozzles dispense the sauces, syrups or other flowable foods. The dispensing nozzles couple to a movable nozzle assembly. The dispensing machine further comprises a controller that controls the dispensing of the sauces, syrups, and other flowable foods. The controller couples to the dispensing nozzles and the storage containers. And further included is a pattern selection panel to select a pattern to dispense from one or more stored patterns, where the pattern selection panel couples to the controller. The present invention may include a spinning assembly that spins the food serving piece. Further, the dispensing machine may include a temperature selection panel to select the temperature of the storage containers, where the temperature selection panel couples to the controller. A further option is a flow rate selection panel to select the flow rate of the sauces, syrups, or other flowable foods being dispensed through the dispensing nozzles, where the flow rate selection panel couples to the controller. Additionally, the dispensing machine may include a centering assembly that centers the food serving piece. And, the dispensing machine may include a data port that allows additional access to the controller and the stored patterns.

Other embodiments of the present invention will be apparent to those skilled in the art after considering this disclosure or practicing the disclosed invention. The specification and examples above are exemplary only, with the true scope of the present invention being determined by the following claims.

I claim the following invention:

1. (canceled)

2. A dispensing machine capable of applying a programmed pattern of one or more sauces, syrups, or other flowable foods to a serving dish, food item, or other surface, comprising:
one or more storage containers that store sauces, syrups, or other flowable foods
one or more dispensing nozzles that couple to a corresponding said storage container wherein said dispensing nozzles dispense the sauces, syrups or other flowable foods, said dispensing nozzles couple to a movable nozzle assembly;
a controller that controls the dispensing of the sauces, syrups, and other flowable foods; said controller couples to said movable nozzle assembly and said storage containers;
a pattern selection panel to select a pattern to dispense from one or more stored patterns, said pattern selection panel couples to said controller.

3. A method to make a dispensing machine to apply a programmed pattern of one or more sauces, syrups, or other flowable foods to a serving dish, food item, or other surface, comprising:
providing one or more storage containers that store sauces, syrups, or other flowable foods;
coupling one or more dispensing nozzles to a corresponding said storage container wherein said dispensing nozzles dispense the sauces, syrups or other flowable foods, said dispensing nozzles couple to a movable nozzle assembly;
coupling a controller to said movable nozzle assembly and said storage containers; said controller controls the dispensing of the sauces, syrups, and other flowable foods;
coupling a pattern selection panel to said controller, said pattern selection panel selects a pattern to dispense from one or more stored patterns.

4. A method to use a dispensing machine to apply a programmed pattern of one or more sauces, syrups, or other flowable foods to a serving dish, food item, or other surface, comprising:
storing sauces, syrups, or other flowable foods in one or more storage containers;
dispensing the sauces, syrups or other flowable foods through one or more dispensing nozzles, said dispensing nozzles couple to a corresponding said storage container, said dispensing nozzles couple to a movable nozzle assembly;
controlling the dispensing of the sauces, syrups, and other flowable foods with a controller; said controller couples to said movable nozzle assembly and said storage containers;
selecting a pattern to dispense from one or more stored patterns with a pattern selection panel, said pattern selection panel couples to said controller.

5. A program storage device readable by a computing device that tangibly embodies a program of instructions executable by the computing device to perform a method to use a dispensing machine to apply a programmed pattern of one or more sauces, syrups, or other flowable foods to a serving dish, food item, or other surface, comprising:
storing sauces, syrups, or other flowable foods in one or more storage containers;
dispensing the sauces, syrups or other flowable foods through one or more dispensing nozzles, said dispensing nozzles couple to a corresponding said storage container, said dispensing nozzles couple to a movable nozzle assembly;
controlling the dispensing of the sauces, syrups, and other flowable foods with a controller; said controller couples to said movable nozzle assembly and said storage containers;
selecting a pattern to dispense from one or more stored patterns with a pattern selection panel, said pattern selection panel couples to said controller.

6. (canceled)

7. (canceled)

8. (canceled)

9. (canceled)

10. (canceled)

11. The dispensing machine according to claim 2 further comprising the capability to select the desired holding temperature of each flowable food used to create the patterns.

12. The dispensing machine according to claim 2 further comprising the capability to download new patterns from an external device such as a personal computer.

13. The dispensing machine according to claim 2 further comprising the capability to automatically center the item to be patterned under the dispensing nozzles.

14. The dispensing machine according to claim 2 further comprising the capability to individually calibrate the flow rate of each flowable food.

15. The dispensing machine according to claim 2 further comprising the capability to spin the item to be patterned in a horizontal plane in order to decrease the time needed to create certain patterns.

16. The method according to claim 3 further comprising the capability to select the desired holding temperature of each flowable food used to create the patterns.

17. The method according to claim 3 further comprising the capability to download new patterns from an external device such as a personal computer.

18. The method according to claim 3 further comprising the capability to automatically center the item to be patterned under the dispensing nozzles.

19. The method according to claim 3 further comprising the capability to individually calibrate the flow rate of each flowable food.

20. The method according to claim 3 further comprising the capability to spin the item to be patterned in a horizontal plane in order to decrease the time needed to create certain patterns.

21. The method according to claim 4 further comprising the capability to select the desired holding temperature of each flowable food used to create the patterns.

22. The method according to claim 4 further comprising the capability to download new patterns from an external device such as a personal computer.

23. The method according to claim 4 further comprising the capability to automatically center the item to be patterned under the dispensing nozzles.

24. The method according to claim 4 further comprising the capability to individually calibrate the flow rate of each flowable food.

25. The method according to claim 4 further comprising the capability to spin the item to be patterned in a horizontal plane in order to decrease the time needed to create certain patterns.

26. The program storage device according to claim 5 further comprising the capability to select the desired holding temperature of each flowable food used to create the patterns.

27. The program storage device according to claim 5 further comprising the capability to download new patterns from an external device such as a personal computer.

28. The program storage device according to claim 5 further comprising the capability to automatically center the item to be patterned under the dispensing nozzles.

29. The program storage device according to claim 5 further comprising the capability to individually calibrate the flow rate of each flowable food.

30. The program storage device according to claim 5 further comprising the capability to spin the item to be patterned in a horizontal plane in order to decrease the time needed to create certain patterns.
